(19) United States
(12) Patent Application Publication
(10) Pub. No.: US 2004/0059858 A1
(43) Pub. Date: Mar. 25, 2004

(54) Methods and arrangements to enhance a downbound path

(76) Inventors: Robert G. Blankenship, Tacoma, WA (US); Kenneth C. Creta, Gig Harbor, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/252,307

(22) Filed: Sep. 23, 2002

(51) Int. Cl. G06F 13/14

(52) U.S. Cl. 710/305

(57) ABSTRACT

Embodiments of the invention may monitor or manage the number of retries sent to a node by reserving an entry or path to an outbound port when the node is starved. Some embodiments associate a number of retries with a node in a buffer. Several embodiments compare the number of retries associated with the node against a retry limit to trigger reservation of an entry in a queue. Many embodiments may reserve the entry after the number of retries reaches or surpasses the retry limit. Further embodiments provide a count controller to count the number of retries and a retry controller, responsive to the count controller, to reserve a path to an outbound port. Other embodiments prevent transactions from one node from transmitting to an outbound port via a reserved path when the number of retries for another node is near or approaches the retry limit.

### BACKGROUND

1. Field of the Technology

An embodiment of the invention pertains generally to processors, and in particular pertains to coherency in cache memory.

2. Description of the Related Art

Multiple-processor systems such as desktop computers, laptop computers and servers typically couple processors and main memory to ports for I/O devices via nodes and an interface. The interface, such as an I/O controller or bridge, manages various incoming requests or transactions from the nodes. Some of these transactions, referred to as non-deferred transactions, may not be rejected. Other transactions, referred to as deferred transactions, may be rejected so the interface may respond to the corresponding node with a retry, indicating that the interface is too busy to handle the transaction and that the transaction should be retried at a later time. The interface receives transactions, or I/O requests, and determines whether the transactions will be sent to corresponding I/O device(s) or deferred for later processing.

In such a multiple node system, the request-retry approach facilitates a beat pattern or starvation state for the nodes. For example, a node may receive retries each time a transaction is transmitted to the interface if the interface continually accepts transactions from other nodes. As a result, there is no guarantee that the starved node will make forward progress. One mechanism to attenuate starvation requires the node to prioritize the transaction by adding information to the transaction. However, this mechanism is costly since it increases the memory requirements in the interface to the source of the request, and in some circumstances, the bus width.

Another mechanism prevents starvation by increasing the buffer size in the interface to the target to allow all of the incoming transactions to be queued, i.e. eliminating retries. However, interfaces typically do not have such a large buffer and the size of the buffer depends significantly on the number of nodes coupled to the interface.

### BRIEF DESCRIPTION OF THE DRAWINGS

In the accompanying drawings, like references may indicate similar elements:

FIG. 1 depicts an embodiment of a system to transact between an ordered and an unordered interface with a processor coupled with an I/O hub.

FIG. 2 depicts an embodiment of an apparatus with a retry controller and count controller to prevent or attenuate starvation of transactions from multiple sources.

FIG. 3 depicts a flow chart of an embodiment to prevent or attenuate starvation of transactions from multiple sources.

FIG. 4 depicts a flow chart of an embodiment to prevent starvation of transactions from multiple sources.

FIG. 5 depicts an embodiment of a machine-accessible medium comprising instructions to prevent or attenuate starvation of transactions from multiple sources.

### DETAILED DESCRIPTION

The following is a detailed description of example embodiments of the invention depicted in the accompanying drawings. The example embodiments are in such detail as to clearly communicate the invention. However, the amount of detail offered is not intended to limit the anticipated variations of embodiments. The variations of embodiments anticipated for the present invention are too numerous to discuss individually so the detailed descriptions below are designed to make such embodiments obvious to a person of ordinary skill in the art.

Embodiments of the present invention may monitor or manage the number of retries sent to a node by reserving an entry or path to an outbound port when the node is starved. Some embodiments associate a number of retries with a node in a buffer. Several embodiments compare the number of retries associated with the node against a retry limit to trigger reservation of an entry in a queue. Many embodiments may reserve the entry after the number of retries reaches or surpasses the retry limit. Further embodiments provide a count controller to count the number of retries and a retry controller, responsive to the count controller, to reserve a path to an outbound port. Other embodiments prevent transactions from one node from transmitting to an outbound port via a reserved path when the number of retries for another node is near or approaches the retry limit.

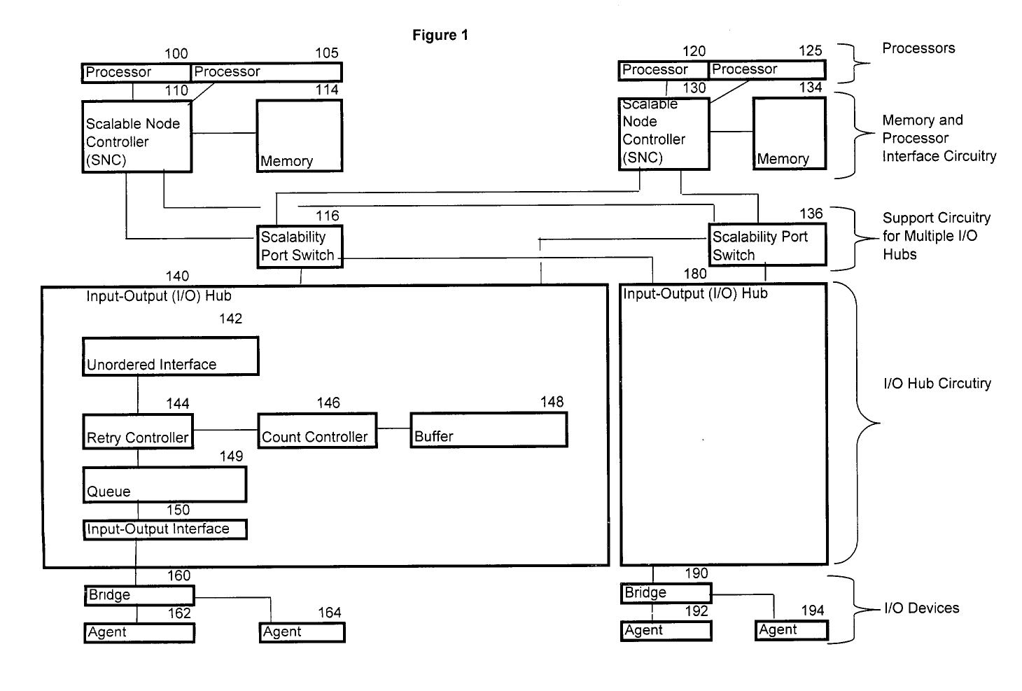

Referring now to FIG. 1, there is shown an embodiment of a system to transact between an ordered and an unordered interface with a processor coupled with an I/O hub. The embodiment may comprise an unordered domain, ordered domain, and one or more hubs to bridge between the unordered domain and the ordered domain. The unordered domain may comprise processors such as processors 100, 105, 120, and 125; processor interface circuitry, such as scalable node controllers 110 and 130; and memory 114 and 134. The one or more hubs may comprise I/O hub circuitry, such as I/O hub 140 and I/O hub 180; and the ordered domain may comprise I/O devices, such as bridges 160 and 190. In embodiments that may comprise more than one I/O hub, such as I/O hub 140 and I/O hub 180, support circuitry may couple the processor interface circuitry with the multiple hubs to facilitate transactions between I/O hubs 140 and 180 and processors 100, 105, 120, and 125.

Scalable node controllers 110 and 130 may couple with processors 100 and 105, and 120 and 125, respectively, to apportion tasks between the processors 100, 105, 120, and 125. In some of these embodiments, scalable node controller 110 may apportion processing requests between processor 100 and processor 105, as well as between processors 100 and 105 and processors 120 and 125, for instance, based upon the type of processing request and/or the backlog of processing requests for the processors 100 and 105 and processors 120 and 125.

In several embodiments, scalable node controller 110 may also coordinate access to memory 114 between the processors, 100 and 105, and the I/O hubs, 140 and 180. The support circuitry for multiple I/O hubs, such as scalability port switches 116 and 136, may direct traffic to scalable node controllers 110 and 130 based upon a backlog of transactions. In addition, scalability port switches 116 and 136 may direct transactions from scalable node controllers 110 and 130 to I/O hubs 140 and 180 based upon destination addresses for the transactions. In many embodiments, memory 114 and memory 134 may share entries. In several embodiments, memory 114 and memory 134 may comprise an entry that may not be shared so a write transaction may be forwarded to either memory 114 or memory 134.

In the present embodiment, SNC 110 and SNC 130 may comprise nodes responsible for transmit transaction downbound and maintaining ordering requirements. For example a downbound transaction from processor 100 may be transmitted to SNC 110 and SNC 110 may forward the transaction downbound to I/O hub 140. I/O hub 140 may forward the transaction to bridge 160 or respond to SNC 110 with a retry. SNC 110 may be responsible for retransmitting the transaction after receiving a retry.

I/O hubs 140 and 180 may operate in a similar manner to bridge transactions between an ordered domain and an unordered domain based upon an availability of space, determine that a node of the nodes is starved, and allocate space to transmit a transaction of the transactions from the node to the ordered domain. I/O hubs 140 and 180 may bridge transactions between an ordered domain and an unordered domain by routing traffic between I/O devices and scalability port switches 116 and 136. In some embodiments, the I/O hubs 140 and 180 may provide peer-to-peer communication between I/O interfaces. In particular, I/O hub 140 may comprise unordered interface 142, retry controller 144, count controller 146, buffer 148, pending data queue 149, and an I/O interface 150.

Unordered interface 142 may facilitate communication between I/O hub 140 and a scalable node controller such as 110 and 130 with circuitry for a scalability port protocol layer, a scalability port link layer, and a scalability port physical layer. In some embodiments, unordered interface 142 may comprise simultaneous bi-directional signaling. Unordered interface 142 may couple to scalability port switches 116 and 136 to transmit transactions between scalability node controllers 110 and 130 and agents 162, and 164. Transactions between unordered interface 142 and scalability node controllers 110 and 130 may transmit in no particular order or in an order based upon the availability of resources or the ability for a target to complete a transaction. The transmission order may not be based upon, for instance, a particular transaction order according to ordering rules such as a PCI bus. For example, when processor 110 may initiate a transaction such as a memory mapped I/O write (MMIO) to write data to memory of agent 162, retry controller 144 may determine whether to accept or reject the transaction based upon the availability of space in pending data queue 149. Pending data queue 149 may store transactions awaiting transmission to agents 162 and 164. If pending data queue 149 is full, retry controller 144 may reject the transaction from processor 100 by responding to SNC 110 with a retry. On the other hand, if space is available in pending data queue 149 for the transaction, the transaction may be stored in pending data queue 149 to await transmission to agent 162.

Retry controller 144 may also reserve a path for a starved node or a node that has been sent a number of retries near a retry limit. In some of these embodiments, retry controller 144 may comprise reservation circuitry. For instance, a retry limit for a first node may be set at four. After four retries are sent to the first node, reservation circuitry may allocate space in pending data queue 149 for a subsequent transaction from the first node. After the subsequent transaction is stored in the first entry of pending data queue 149, the reservation associated with the first node may be removed. In some situations, a second node may reach the retry limit while the first entry is reserved for the first node. In many of these embodiments, the reservation circuitry may reserve the first entry for the second node after storing the subsequent transaction in the first entry. In other embodiments, a second entry may be reserved for the second node. However, in many embodiments, at least one entry remains available for transactions based upon the order of receipt of the transactions.

Count controller 146 may couple with retry controller 144 to determine that a node is starved based upon a retry count associated with the node. Count controller 146 may count the number of retries sent to a node, associate the number with the node, and compare the number to a retry limit. In some embodiments, the retry limit is selected based upon performance and/or based upon a determination of the point at which a node is starved or on the verge of starvation. Count controller 146 may transmit a signal to retry controller 144 to indicate that a node is starved or to indicate that a path or entry may be reserved for the node. In several embodiments, count controller 146 may count the number of retries associated with a node until the number reaches the retry limit. In other embodiments, count controller 146 may continue count the number of retries associated with a node until one or more transactions associated with the node are forwarded to pending data queue 149. In some of these embodiments, the number of retries associated with a node may be reset after the one or more transactions are forwarded to pending data queue 149.

Buffer 148 may comprise memory to associate a retry count with the node. In several embodiments, buffer 148 may comprise an entry per node with a number of bits associated with an entry sufficient to count retries associated with the node. For instance, in embodiments that count until the retry limit is reached, the number of bits associated with an entry may be sufficient to store a value equivalent or substantially equivalent to the retry limit. In many of these embodiments, buffer 148 may comprise an entry to store the retry limit associated with a node. For instance, in response to sending a retry to SNC 110, count controller 146 may increment a retry count associated with SNC 110 in buffer 148 and compare the retry count to a retry limit. In other embodiments, count controller 146 may compare the retry count to the retry limit before incrementing the retry count. If the retry count associated with SNC 110 is equivalent to or greater than the retry limit, count controller 146 may transmit a signal to retry controller 144 to indicate that an entry in pending data queue 149 may be reserved for a subsequent transaction from SNC 110.

In other embodiments, buffer 148 may comprise a bit to associate an entry with a node. For example, buffer 148 may comprise a memory store associated an entry with a source identification (ID). Such embodiments may allow an entry to be associated with more than one source node to facilitate prioritizing nodes.

Queue 149 may comprise space or entries to store a transaction to be forwarded to an outbound port. For example, pending data queue may comprise four entries. Each entry may comprise a number of bits to facilitate storage of a MMIO. After bandwidth becomes available to forward a transaction to the ordered domain via I/O interface 150, a transaction may be forwarded and an entry may become available in pending data queue for another transaction. In many embodiments, when none of the nodes are starved or reached a retry limit, the entry may be available for the next transaction received by retry controller 144. On the other hand, if a first node has been sent a number of retries near or at the retry limit, one entry in pending data queue 149 may be reserved for a subsequent transaction from the first node. In such situations, transactions from other nodes may be forwarded to pending data queue 149 when an entry other than the one reserved entry is available. Otherwise, the transactions from other nodes may be retried.

After a subsequent transaction is received from the first node and stored in the one reserved entry, that entry may be available for transactions from other nodes after the subsequent transaction is forwarded to I/O interface 150 or moved into another entry of pending data queue 149.

The ordered domain in the present embodiment, may comprise I/O devices such as bridges 160 and 190, and agents 162, 164, 192, and 194. Bridge 160, for example, may receive downbound transactions such as an MMIO addressed to agents 162 and 164.

I/O hub 180 may operate in a similar manner to bridge transactions from SNC 110 and 130 to bridge 190. Bridge 190 may forward transactions from a queue of I/O hub 180 to agents 192 and 194 based on a hub ID associated with the transactions.

In the present embodiment, bridges 160 and 190, couple one or more agents 162, 164, 192, and 194 to the I/O hubs 140 and 180 from an ordered domain such as a peripheral component interconnect (PCI) bus, a universal serial bus (USB), or an infiniband channel. The agents 162, 164, 192, and 194 may transact upbound or peer-to-peer via I/O hubs 140 and 180. In many of these embodiments, agents 162, 164, 192, and 194 may transact with any processor and processors 100, 105, 120, and 125 may transact with any agent.

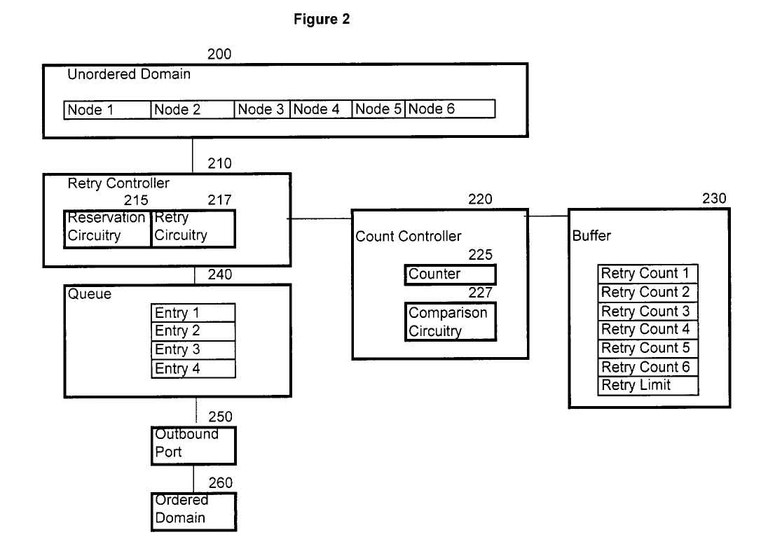

Referring now to FIG. 2, there is shown an embodiment of an apparatus with a retry controller 210 and count controller 220 to prevent starvation of transactions from multiple sources, nodes 1-6, in unordered domain 200. The embodiment may comprise unordered domain 200, retry controller 210, count controller 220, buffer 230, queue 240, outbound port 250, and ordered domain 260.

Unordered domain 200 may comprise nodes 1-6 to transmit transactions to ordered domain 260. In many embodiments, nodes 1-6 may comprise nodes such as SNC's coupled with one or more sources of the transactions. Source ID's may associate the transactions with a node of nodes 1-6, and in some embodiments, with a source of the node.

Retry controller 210 may forward a transaction received from unordered domain 200 to queue 240 when an entry in queue 240 is available and may reserve an entry in queue 240 for the transaction based upon a determination that a node associated with the transaction is starved. Retry controller 210 may comprise retry circuitry 217 and reservation circuitry 215. Retry circuitry 217 may couple with an inbound port associated with unordered domain 200 to respond to a transaction with a retry when queue 240 is full.

Reservation circuitry 215 may reserve an entry in queue 240 based upon a determination that the node is starved. For example, retry controller 210 may receive four transactions associated with node 1 and determine that the entries 1-4 of queue 240 are full. Retry circuitry 217 may transmit a retry to node 1 after receipt of each transaction based upon the determination that queue 240 is full. After responding to node 1 the number of consecutive times specified by the retry limit, retry controller 210 may be communicatively coupled with count controller 220 to receive an indication that node 1 is starved or that an entry in queue 240 may be reserved for node 1. Reservation circuitry 215 may respond by allocating the entry 1 of queue 240 for the next transaction received from node 1. Upon forwarding a subsequent transaction from node 1 to queue 240, retry controller 210 may receive an indication to terminate the reservation of the entry for node 1 or to change to reservation to a reservation for another starved node.

Count controller 220 may couple with retry controller 210 to determine that the node is starved based upon a retry count associated with the node. Count controller 220 may comprise counter 225 and comparison circuitry 227. Counter 225 may track a number of consecutive retries associated with a node. In some embodiments, counter 225 may increment (or decrement, pending on whether an up counter or down counter is used—all references herein to incrementing a counter may also include decrementing a counter) a count associated with a node based upon a number of reties sent to the node.

In many embodiments count controller 220 may comprise comparison circuitry 227 to compare the number against a retry limit. The retry limit may be selected or determined to indicate starvation of a node based upon the retry count associated with the node. In several embodiments, the retry limit may be selected or determined to optimize the efficiency of transmission of transactions such as deferred transactions from unordered domain 200 to ordered domain 260. In further embodiments, the retry limit may be based a number of retries sufficient to indicate a beat pattern.

Buffer 230 may associate a retry count with a node of nodes 1-6. In several embodiments, buffer 230 may comprise memory to store an association between a number of retries and the node. For instance, buffer 230 may comprise retry counts 1-6 to correspond to nodes 1-6, respectively. Thus, after a retry is transmitted to node 1, retry count 1 may be incremented or decremented accordingly. In several embodiments, buffer 230 may further comprise memory to store a retry limit although it should be appreciated that value for the retry limit may be stored in volatile or non-volatile memory anywhere and coupled with count controller 220.

Queue 240 may provide a path to forward a transaction to outbound port 250. Queue 240 may comprise an entry, such as entries 1-4, to store the transaction awaiting bandwidth to transmit to ordered domain 260 via outbound port 250. In other embodiments, queue 240 may comprise more or less entries and, in some embodiments, the number of entries that may be reserved in queue 240 may be dependent upon the number of entries comprised by queue 240.

Outbound port 250 may comprise, for example, an I/O interface of a hub. Ordered domain 260 may comprise a domain having transaction ordering rules such as peripheral component interconnect (PCI) ordering rules. In the present embodiment, ordered domain 260 may comprise agents to receive transactions from nodes 1-6.

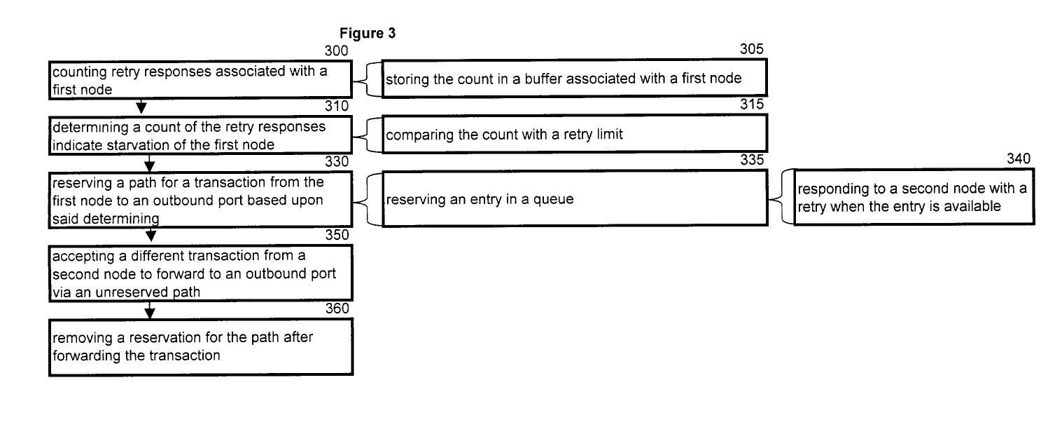

Referring now to FIG. 3, there is shown depicts a flow chart of an embodiment to prevent starvation of transactions from multiple sources. The embodiment may comprise counting retry responses associated with a first node 300; determining a count of the retry responses indicate starvation of the first node 310; and reserving a path for a transaction from the first node to an outbound port based upon said determining 330. Further embodiments may comprise accepting a different transaction from a second node to forward to an outbound port via an unreserved path 350 and removing a reservation for the path after forwarding the transaction 360.

Counting retry responses associated with a first node 300 may modify a value or retry count that is associated with the first node. Some embodiments may increment a retry count associated with the first node. In many of these embodiments, a separate retry count may be associated with each node that may be sent a retry. Other embodiments may associate a retry count with the first node by associating a source ID, or part thereof, with the retry count.

Counting retry responses associated with a first node 300 may comprise storing the count in a buffer associated with a first node 305. Storing the count in a buffer associated with a first node 305 may comprise storing the count in a buffer having a memory location for each node or with each node that may receive a retry. For example, an embodiment having four potential nodes to associate with retry counts may comprise four memory locations, one memory location for each node. As a result, counting retry responses for node 1 may comprise modifying the contents of memory location one in the buffer.

Determining a count of the retry responses indicate starvation of the first node 310 may determine that the count indicates a beat pattern. For instance, nodes 1-6 may be serviced in order. Node 1 may transmit a transaction and may receive a retry in response because no bandwidth is available to forward the transaction to an ordered domain. Subsequently, bandwidth may become available, however, a transaction from node 6 may use the bandwidth. As a result, when node 1 transmits a subsequent transaction, no bandwidth is available to transmit the subsequent transaction. If node 1 continually receives retries for consecutive attempts to transmit a transaction to the ordered domain, the transmit-retry loop comprises a beat pattern. The beat pattern may indicate that node 1 is starved.

In some embodiments, determining a count of the retry responses indicate starvation of the first node 310 may comprise comparing the count with a retry limit 315. Comparing the count with a retry limit 315 may determine a node is starved based upon the number of retries a node receives for consecutive attempts to transmit a downbound transaction.

Further comparing the count with a retry limit 315 may determine a node is starved based upon the number of retries associated with efficient transmission of downbound transactions from the unordered domain to the ordered domain. In many of these embodiments, the selection of the retry limit may be heuristically chosen.

Reserving a path for a transaction from the first node to an outbound port based upon said determining 330 may reserve bandwidth to transmit to the outbound port for a transaction associated with a starved node. Reserving a path for a transaction from the first node to an outbound port based upon said determining 330 may comprise reserving an entry in a queue 335. Reserving an entry in a queue 335 may comprise reserving the next available entry or a specific entry the next time that specific entry is available for a subsequent transaction from the first node. For example, one embodiment may reserve the first entry of a queue for a starved node. After the contents of the first entry is forwarded to another location or transmitted via the outbound port, the entry may not be filled by a transaction from nodes other than the first node. In response to receipt of a transaction from the first node, the transaction is stored in the first entry.

Reserving an entry in a queue 335 may comprise responding to a second node with a retry when the entry is available 340. For instance, the first entry of a queue may be reserved or allocated for a transaction from the first node and the entry may be available to receive a transaction and the remainder of the queue may be full. A transaction from a different node may be received and a retry may be transmitted to the different node even though the first entry is available because the first entry is reserved for a subsequent transaction associated with the first node.

Accepting a different transaction from a second node to forward to an outbound port via an unreserved path 350 may comprise storing a transaction in an entry in the queue that is not reserved for a starved node. For instance, when the first node is starved and the first entry of a queue is reserved for a subsequent transaction from the first node, a transaction from a second node may accepted and stored in a second entry of the queue when the second entry is available to accept a transaction.

Removing a reservation for the path after forwarding the transaction 360 may comprise reverting a reserved entry to an unreserved entry after one or more transactions are accepted from a starved node. In other situations, the reserved entry may be reserved for a second starved node rather than reverted back to an unreserved entry.

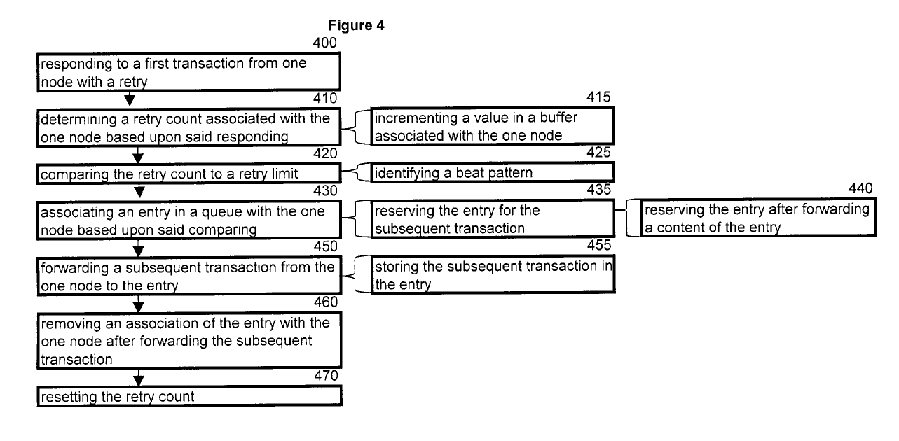

Referring now to FIG. 4, there is shown depicts a flow chart of an embodiment to prevent or attenuate starvation of transactions from multiple sources. The embodiment may comprise responding to a first transaction from one node with a retry 400; determining a retry count associated with the one node based upon said responding 410; comparing the retry count to a retry limit 420; associating an entry in a queue with the one node based upon said comparing 430; and forwarding a subsequent transaction from the one node to the entry 450. Further embodiments may comprise removing an association of the entry with the one node after forwarding the subsequent transaction 460 and resetting the retry count 470.

Responding to a first transaction from one node with a retry 400 may comprise receiving the first transaction, determining that no entry in a queue is available to accept a transaction, and rejecting the transaction by transmitting a retry to the one node. Determining that no entry in a queue is available may comprise monitoring the queue to determine a transaction is forwarded from the queue via an outbound port, requesting a status of an entry in the queue, or reading the contents of memory associated with the status of an entry in the queue.

Determining a retry count associated with the one node based upon said responding 410 may modify the retry count after a transaction from the one node is rejected. Determining a retry count associated with the one node based upon said responding 410 may comprise incrementing a value in a buffer associated with the one node 415. Incrementing a value in a buffer associated with the one node 415 may increase the value to indicate a count of retries forwarded to the one node.

Comparing the retry count to a retry limit 420 may compare the retry count against a number, wherein the number is determined to facilitate efficient bridging of transactions between an unordered domain and an ordered domain. In other embodiments, the number may be determined to indicate starvation of a node.

In further embodiments, comparing the retry count to a retry limit 420 may comprise identifying a beat pattern 425. Identifying a beat pattern 425 may comprise identifying a pattern of responding to consecutive transactions from the one node with retries.

Associating an entry in a queue with the one node based upon said comparing 430 may associate the entry with receipt of one or more selected nodes based upon a comparison of the number of retries associated with the one or more nodes against a retry limit. For instance, a first entry in a queue may be associated with the first node of after a comparison indicates that the number of retries associated with the first node is equal to or greater than a retry limit associated with the first node. Further embodiments may also associate a second node with the entry after a comparison indicates that the second node has been sent a number of retries at least equivalent to the retry limit.

Associating an entry in a queue with the one node based upon said comparing 430 may comprise reserving the entry for the subsequent transaction 435. For example, after a transaction for the one node is rejected and a comparison of the number of retries associated with the one node indicates that the one node may be starved, the first entry may be reserved for the next transaction from the one node that is received. In some situations, the first entry may be reserved although the entry contains a transaction. In such situations, the first entry is reserved for the next transaction received from the one node after the first entry becomes available to accept a transaction.

Reserving the entry for the subsequent transaction 435 may comprise reserving the entry after forwarding a content of the entry 440. Reserving the entry after forwarding a content of the entry 440 may reserve the entry for the one node after the entry becomes available to accept a transaction.

Forwarding a subsequent transaction from the one node to the entry 450 may comprise storing the subsequent transaction in the entry 455. Storing the subsequent transaction in the entry 455 may secure an order for transmitting the subsequent transaction via the outbound port. For instance, if the queue is a first in, first out (FIFO) queue, storing the subsequent transaction in the top entry of the queue may ensure that the subsequent transaction is fourth in line to be forwarded to the outbound port. Similarly, if the entry is the bottom of the queue, the transaction may be the next transaction to forward to the outbound port.

Removing an association of the entry with the one node after forwarding the subsequent transaction 460 may remove an entry allocation for the one node after the subsequent transaction is stored in the reserved entry. In some embodiments, removing the association may comprise implementing a new reservation. In other embodiments, removing the association may comprise reverting the entry to an unreserved entry.

Resetting the retry count 470 may comprise modifying the retry count associated with the one node to indicate zero retries. In other embodiments, resetting the retry count 470 may comprise setting the retry count to a number based upon a priority associated with the one node or modifying the retry count to indicate a number of retries based upon the number of retries associated with the one node prior to storing the subsequent transaction in the entry.

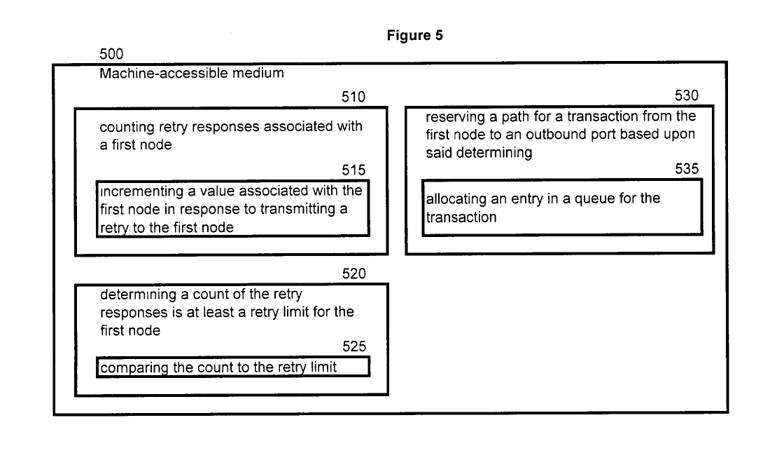

Referring now to FIG. 5, a machine-accessible medium embodiment of the present invention is shown. A machine-accessible medium includes any mechanism that provides (i.e. stores and or transmits) information in a form accessible by a machine (e.g., a computer, network device, personal digital assistant, manufacturing tool, any device with a set of one or more processors, etc.). For example, a machine-accessible medium may include recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.); or the like. Several embodiments of the present invention may comprise more than one machine-accessible medium depending on the design of the machine.

In particular, FIG. 5 shows an embodiment of a machine-accessible medium 500 comprising instructions for counting retry responses associated with a first node 510; determining a count of the retry responses is at least a retry limit for the first node 520; and reserving a path for a transaction from the first node to an outbound port based upon said determining 530. Instructions for counting retry responses associated with a first node 510 may modify a retry count associated with the first node based upon a number of retries transmitted to the first node.

Instructions for counting retry responses associated with a first node 510 may comprise incrementing a value associated with the first node in response to transmitting a retry to the first node 515. Incrementing a value associated with the first node in response to transmitting a retry to the first node 515 may increment a value in a buffer.

Instructions for determining a count of the retry responses is at least a retry limit for the first node 520 may comprise determining a retry count associated with the first node and comparing the retry count to the retry limit 525. In some embodiments, a buffer or memory location associated with the first node may comprise an representation such as a bit to indicate that the retry limit has been reached or that the retry count is sufficiently high to reserve a path or entry for the first node. For instance, counting retry responses associated with a first node 510 may count the retry responses until the retry limit is reached and then replace the retry count with data to indicate that the retry limit has been reached. In many of these embodiments, the value may remain in the buffer until a transaction from the first node is forwarded to a queue or an outbound port. After forwarding the transaction, the value may be reset to indicate that the first node is not starved.

Instructions for reserving a path for a transaction from the first node to an outbound port based upon said determining 530 may facilitate forwarding a subsequent transaction from the first node to the outbound port to prevent starvation of the first node. Instructions for reserving a path for a transaction from the first node to an outbound port based upon said determining 530 may comprise allocating an entry in a queue for the transaction 535. For example, after a determination that the first node is starved, an entry in a pending data queue may be reserved for the next or a subsequent transaction from the first node. After the entry becomes available to receive a transaction, transactions from nodes other than the first node may not be stored in the entry but the following transaction received that is associated with the first node may be stored in the entry.

What is claimed is:

1. An apparatus, comprising:
a queue to forward a transaction to an outbound port;
a retry controller to forward the transaction to said queue when an entry in said queue is available and to reserve the entry for the transaction based upon a determination that a node associated with the transaction is starved;
a count controller coupled with said retry controller to determine that the node is starved based upon a retry count associated with the node; and
a buffer to associate a retry count with the node.

2. The apparatus of claim 1, wherein said queue comprises an entry to store the transaction.

3. The apparatus of claim 1, wherein said retry controller comprises reservation circuitry to reserve an entry in said queue based upon a determination that the node is starved.

4. The apparatus of claim 1, wherein said retry controller comprises retry circuitry coupled with an inbound port to respond to the transaction with a retry.

5. The apparatus of claim 1, wherein said retry controller is communicatively coupled with said count controller to indicate a response to receipt of the transaction.

6. The apparatus of claim 1, wherein said count controller comprises a counter to track a number of consecutive retries associated with the node.

7. The apparatus of claim 6, wherein said count controller comprises comparison circuitry to compare the number against a retry limit.

8. The apparatus of claim 1, wherein said buffer comprises memory to store an association between a number of retries and the node.

9. A method, comprising:
counting retry responses associated with a first node;
determining a count of the retry responses indicate starvation of the first node; and
reserving a path for a transaction from the first node to an outbound port based upon said determining.

10. The method of claim 9, further comprising accepting a different transaction from a second node to forward to an outbound port via an unreserved path.

11. The method of claim 9, further comprising removing a reservation for the path after forwarding the transaction.

12. The method of claim 9, wherein said counting retry responses comprises storing the count in a buffer associated with a first node.

13. The method of claim 9, wherein said determining a count of retry responses comprises comparing the count with a retry limit.

14. The method of claim 9, wherein said reserving a path comprises reserving an entry in a queue.

15. The method of claim 14, wherein reserving an entry in a queue comprises responding to a second node with a retry when the entry is available.

16. A method, comprising:
responding to a first transaction from one node with a retry;
determining a retry count associated with the one node based upon said responding;
comparing the retry count to a retry limit;
associating an entry in a queue with the one node based upon said comparing; and
forwarding a subsequent transaction from the one node to the entry.

17. The method of claim 16, further comprising:
removing an association of the entry with the one node after forwarding the subsequent transaction; and
resetting the retry count.

18. The method of claim 16, wherein said determining a retry count comprises incrementing a value in a buffer associated with the one node.

19. The method of claim 16, wherein said comparing the retry count to a retry limit comprises identifying a beat pattern.

20. The method of claim 16, wherein said associating an entry in a queue comprises reserving the entry for the subsequent transaction.

21. The method of claim 20, wherein reserving the entry comprises reserving the entry after forwarding a content of the entry.

22. The method of claim 16, wherein said forwarding a subsequent transaction comprises storing the subsequent transaction in the entry.

23. A system, comprising:
an unordered domain comprising nodes to transmit transactions;
an ordered domain to receive the transactions; and
a hub to bridge the transactions between said unordered domain and said ordered domain based upon an availability of space, determine that a node of the nodes is starved, and allocate space to transmit a transaction of the transactions from the node to the ordered domain.

24. The system of claim 23, wherein said ordered domain comprises a bridge to couple more than one input-output device to said hub.

25. The system of claim 23, wherein said hub comprises a buffer to store a retry count associated with the node.

26. The system of claim 23, wherein said hub comprises a count controller to determine a retry count associated with the node and compare the retry count to a retry limit to determine that the node is starved.

27. A machine-accessible medium that provides instructions that, if executed by a processor, will cause said processor to perform operations, comprising:
counting retry responses associated with a first node;
determining a count of the retry responses is at least a retry limit for the first node; and
reserving a path for a transaction from the first node to an outbound port based upon said determining.

28. The machine-accessible medium of claim 27, wherein said counting retry responses comprises incrementing a value associated with the first node in response to transmitting a retry to the first node.

29. The machine-accessible medium of claim 27, wherein said determining comprises comparing the count to the retry limit.

30. The machine-readable medium of claim 27, wherein said reserving comprises allocating an entry in a queue for the transaction.
